(19) United States
(12) Patent Application Publication
(10) Pub. No.: US 2025/0206021 A1
(43) Pub. Date: Jun. 26, 2025

(54) DROPLET DISCHARGE HEAD AND RECORDING APPARATUS

(71) Applicants: KYOCERA Corporation, Kyoto (JP); KYOCERA DOCUMENT SOLUTIONS INC., Osaka (JP)

(72) Inventors: Tadao YAMASAKO, Kirishima-shi, Kagoshima (JP); Shinya OTAKA, Stuttgart (DE); Okito OGASAHARA, Osaka-shi, Osaka (JP)

(21) Appl. No.: 18/851,687

(22) PCT Filed: Mar. 30, 2023
(86) PCT No.: PCT/JP2023/013422

§ 371 Date: Sep. 27, 2024

(30) Foreign Application Priority Data
Mar. 30, 2022 (JP) 2022-056993

(51) Int. Cl. B41J 2/14

(52) U.S. Cl. CPC B41J 2/14233; B41J 2002/14491

(57) ABSTRACT

A droplet discharge head according to an embodiment includes a head body, a driver IC, a flexible substrate, and a head substrate. The head body discharges droplets. The driver IC controls driving of the head body. The driver IC is mounted on the flexible substrate, and the flexible substrate is electrically connected to the head body. The head substrate includes a first connector. The flexible substrate includes a second connector 10 corresponding to the first connector, and allows the second connector to be turned inside-out. The second connector is connected to the first connector in a state of being turned inside-out.

### CROSS-REFERENCE TO RELATED APPLICATIONS

This application is a national stage entry according to 35 U.S.C. 371 of PCT Application No. PCT/JP2023/013422 filed on Mar. 30, 2023, which claims priority to Japanese Patent Application No. 2022-056993, filed on Mar. 30, 2022.

### FIELD

The disclosed embodiments relate to a droplet discharge head and a recording apparatus.

### BACKGROUND

As a printing apparatus, an inkjet printer and/or an inkjet plotter using an inkjet recording system are known. Such an inkjet printing apparatus is equipped with a droplet discharge head for discharging droplets.

In such a droplet discharge head, a terminal inserted into a connector of a head substrate is mounted, and a flexible substrate such as a COF (Chip on Film, or Chip on Flexible) electrically connected to the head substrate via the terminal is mounted (see, for example, Patent Literature 1).

### CITATION LIST

### Patent Literature

Patent Literature 1: JP 2013-248755 A

### SUMMARY

### Technical Problem

However, in the conventional droplet discharge head, since the head substrate and the flexible substrate are connected only by inserting the terminal of the flexible substrate into the connector of the head substrate, there is a possibility that the terminal of the flexible substrate falls off from the connector of the head substrate.

An aspect of the embodiments has been made in view of the above, and an object thereof is to provide a droplet discharge head and a recording apparatus capable of firmly connecting a head substrate and a flexible substrate.

### Solution to Problem

A droplet discharge head according to one aspect of an embodiment includes a head body, a driver IC, a flexible substrate, and a head substrate. The head body is configured to discharge droplets. The driver IC is configured to control driving of the head body. On the flexible substrate, the driver IC is mounted, the flexible substrate being electrically connected to the head body. The head substrate has a first connector. The flexible substrate includes a second connector corresponding to the first connector, and allows the second connector to be turned inside-out. The second connector is connected to the first connector in a state of being turned inside-out.

A recording apparatus according to one aspect of an embodiment includes the above-mentioned droplet discharge head.

### Advantageous Effects of Invention

According to one aspect of the embodiments, the head substrate and the flexible substrate can be firmly connected.

### BRIEF DESCRIPTION OF DRAWINGS

FIG. 1 is an explanatory diagram (part 1) of a recording apparatus according to an embodiment.

FIG. 2 is an explanatory diagram (part 2) of the recording apparatus according to the embodiment.

FIG. 3 is an exploded perspective view illustrating a schematic configuration of a droplet discharge head according to the embodiment.

FIG. 4 is an enlarged plan view of the droplet discharge head illustrated in FIG. 3.

FIG. 5 is an enlarged view of a region surrounded by an alternate long and short dash line illustrated in FIG. 4.

FIG. 6 is a cross-sectional view taken along line A-A illustrated in FIG. 4.

FIG. 7 is an explanatory diagram (part 1) of a flexible substrate and a structure around the flexible substrate according to the embodiment.

FIG. 8 is an explanatory diagram (part 1) of a flexible substrate and a structure around the flexible substrate according to the embodiment.

FIG. 9 is a schematic cross-sectional view illustrating connection of a flexible substrate.

FIG. 10 is a schematic cross-sectional view illustrating another example of connection of the flexible substrate.

FIG. 11 is an explanatory view of a front surface of a flexible substrate.

FIG. 12 is an explanatory view of a back surface of the flexible substrate.

FIG. 13 is an explanatory view of another embodiment (part 1) of the flexible substrate.

FIG. 14 is an explanatory view of another embodiment (part 2) of the flexible substrate.

FIG. 15 is an explanatory view of another embodiment (part 3) of the flexible substrate.

### DESCRIPTION OF EMBODIMENTS

Hereinafter, embodiments of a droplet discharge head and a recording apparatus disclosed in the present application will be described in detail with reference to the accompanying drawings. Note that the present invention is not limited by the following embodiments.

As a printing apparatus, an inkjet printer and/or an inkjet plotter using an inkjet recording system are known. Such an inkjet printing apparatus is equipped with a droplet discharge head for discharging droplets.

In such a droplet discharge head, a terminal inserted into a connector of a head substrate is mounted, and a flexible substrate such as a COF electrically connected to the head substrate via the terminal is mounted.

However, in the conventional droplet discharge head, since the head substrate and the flexible substrate are connected only by inserting the terminal of the flexible substrate into the connector of the head substrate, there is a possibility that the terminal of the flexible substrate falls off from the connector of the head substrate.

Therefore, in view of the above-described problems, it is expected to realize a droplet discharge head and a recording apparatus capable of firmly connecting a head substrate and a flexible substrate.

### Configuration of Printer

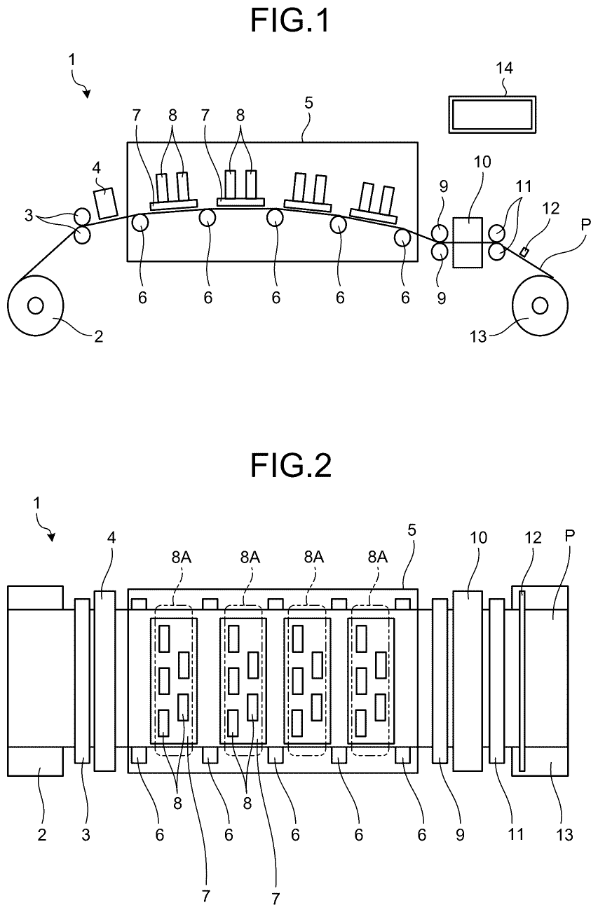

First of all, an outline of a printer 1 which is an example of a recording apparatus according to an embodiment will be described with reference to FIGS. 1 and 2. FIGS. 1 and 2 are explanatory diagrams of the printer 1 according to an embodiment.

Specifically, FIG. 1 is a schematic side view of the printer 1, and FIG. 2 is a schematic plan view of the printer 1. The printer 1 according to the embodiment is, for example, a color inkjet printer.

As illustrated in FIG. 1, the printer 1 includes a sheet feeding roller 2, a guide roller 3, an applicator 4, a head case 5, a plurality of conveying rollers 6, a plurality of frames 7, a plurality of droplet discharge heads 8, a conveying roller 9, a dryer 10, a conveying roller 11, a sensor module 12, and a collection roller 13. The conveying roller 6 is an example of a conveying unit.

The printer 1 further includes a controller 14 that controls the sheet feeding roller 2, the guide roller 3, the applicator 4, the head case 5, the plurality of conveying rollers 6, the plurality of frames 7, the plurality of droplet discharge heads 8, the conveying roller 9, the dryer 10, the conveying roller 11, the sensor 15 module 12, and the collection roller 13.

The printer 1 records an image and/or a character on the printing sheet P by causing droplets to land on the printing sheet P. The printing sheet P is an example of a recording medium. The printing sheet P is wound around the sheet feeding roller 2 before use. Then, the printer 1 conveys the printing sheet P from the sheet feeding roller 2 to the inside of the head case 5 via the guide roller 3 and the applicator 4.

The applicator 4 uniformly applies the coating agent to the printing sheet P. As a result, since the surface treatment can be performed on the printing sheet P, the print quality of the printer 1 can be improved.

The head case 5 accommodates a plurality of conveying rollers 6, a plurality of frames 7, and a plurality of droplet discharge heads 8. Inside the head case 5, a space isolated from the outside is formed in addition to being connected to the outside in a part such as a portion where the printing sheet P enters and exits.

The controller 14 controls at least one of control factors such as temperature, humidity, and atmospheric pressure in the internal space of the head case 5 as necessary. The conveying roller 6 conveys the printing sheet P to the vicinity of the droplet discharge head 8 inside the head case 5.

The frame 7 is a rectangular flat plate, and is located above and close to the printing sheet P conveyed by the conveying roller 6. As illustrated in FIG. 2, the frame 7 is located such that the longitudinal direction is orthogonal to the conveyance direction of the printing sheet P. Inside the head case 5, a plurality of (for example, four) frames 7 are located along the conveyance direction of the printing sheet P.

In the following description, the conveyance direction of the printing sheet P is also referred to as a “sub-scanning direction”. In the following description, a direction orthogonal to the sub-scanning direction and parallel to the printing sheet P is also referred to as a “main scanning direction”.

Liquid, for example, ink is supplied to the droplet discharge head 8 from a liquid tank (not illustrated). The droplet discharge head 8 discharges droplets supplied from the liquid tank.

The controller 14 controls the droplet discharge head 8 based on data such as an image and/or a character to discharge droplets toward the printing sheet P. The distance between the droplet discharge head 8 and the printing sheet P is, for example, about 0.5 to 20 mm.

The droplet discharge head 8 is fixed to the frame 7. The droplet discharge head 8 is fixed to the frame 7 at both ends in the longitudinal direction, for example. The droplet discharge head 8 is located such that the longitudinal direction is orthogonal to the conveyance direction of the printing sheet P.

That is, the printer 1 according to the embodiment is a so-called line printer in which the droplet discharge head 8 is fixed inside the printer 1. Note that the printer 1 according to the embodiment is not limited to a line printer, and may be a so-called serial printer.

The serial printer is a printer of a system that alternately performs a recording operation while moving the droplet discharge head 8 in a direction intersecting the conveyance direction of the printing sheet P, for example, in a direction substantially orthogonal to the conveyance direction, and performs an operation of conveying the printing sheet P.

As illustrated in FIG. 2, a plurality of (for example, five) droplet discharge heads 8 are fixed to one frame 7. FIG. 2 illustrates an example in which three droplet discharge heads 8 are located on the front side and two droplet discharge heads 8 are located on the rear side in the conveyance direction of the printing sheet P. In FIG. 2, the droplet discharge heads 8 are located such that the centers of the droplet discharge heads 8 do not overlap in the conveyance direction of the printing sheet P.

The plurality of droplet discharge heads 8 located in one frame 7 constitute a head group 8A. Four head groups 8A are located along the conveyance direction of the printing sheet P. Ink of the same color is supplied to the droplet discharge heads 8 belonging to the same head group 8A. Thus, the printer 1 can perform printing with inks of four colors using the four head groups 8A.

The color of the ink discharged from each head group 8A is, for example, magenta (M), yellow (Y), cyan (C), and black (K). The controller 14 can print a color image on the printing sheet P by controlling each head group 8A to discharge inks of a plurality of colors on the printing sheet P.

In order to perform the surface treatment of the printing sheet P, the coating agent may be discharged from the droplet discharge head 8 onto the printing sheet P.

At least one of the number of the droplet discharge heads 8 included in one head group 8A and the number of the head groups 8A mounted on the printer 1 can be appropriately changed according to at least one of a printing target and a printing condition. For example, if the color to be printed on the printing sheet P is a single color and a printable range is printed by one droplet discharge head 8, the number of droplet discharge heads 8 mounted on the printer 1 may be one.

The printing sheet P subjected to the printing process inside the head case 5 is conveyed to the outside of the head case 5 by the conveying roller 9 and passes through the inside of the dryer 10. The dryer 10 dries the printing sheet P subjected to the printing process. The printing sheet P dried by the dryer 10 is conveyed by the conveying roller 11 and collected by the collection roller 13.

In the printer 1, by drying the printing sheet P by the dryer 10, the effect of suppressing adhesion between the printing sheet P wound in an overlapping manner and rubbing of undried droplets on the collection roller 13 is improved.

The sensor module 12 includes at least one of a position sensor, a speed sensor, a temperature sensor, and the like. The controller 14 can determine the state of each unit of the printer 1 on the basis of such information from the sensor module 12 and can control each unit of the printer 1.

In the printer 1 described so far, the printing sheet P is used as the printing target (that is, the recording medium). However, the printing target in the printer 1 is not limited to the printing sheet P, and a rolled cloth or the like may be set as the printing target.

Instead of directly conveying the printing sheet P, the printer 1 may place the printing sheet P on a conveyance belt and convey the printing sheet P. By using the conveyance belt, the printer 1 can print on paper sheets, cut pieces of cloth, wood, tiles, and the like.

The printer 1 may discharge droplets containing conductive particles from the droplet discharge head 8 to print a wiring pattern or the like of an electronic device. The printer 1 may cause the droplet discharge head 8 to discharge a predetermined amount of a liquid chemical agent or a droplet containing a chemical agent toward a reaction vessel or the like to produce a chemical agent.

The printer 1 may include a cleaning unit that cleans the droplet discharge head 8. The cleaning unit cleans the droplet discharge head 8 by, for example, wiping and/or capping.

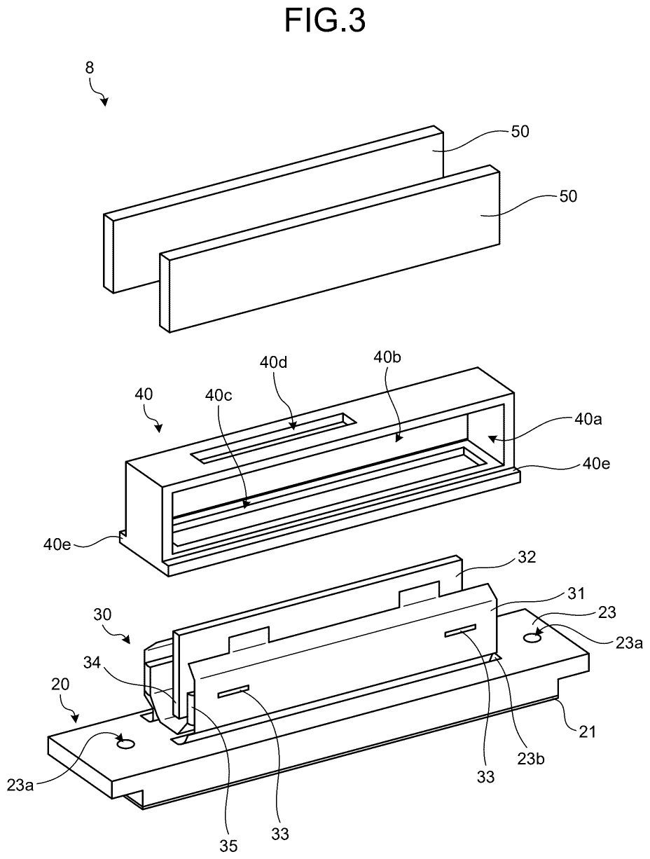

The wiping process is, for example, a process of removing the liquid attached to a second surface 21b (see FIG. 6) by rubbing a surface of a portion where the droplets are discharged, for example, the second surface 21b of a channel member 21 (see FIG. 3) with a flexible wiper.

The capping process is performed as follows, for example. First of all, a cap is put so as to cover a portion to which a droplet is discharged, for example, the second surface 21b of the channel member 21 (this is referred to as capping). As a result, a substantially sealed space is formed between the second surface 21b and the cap.

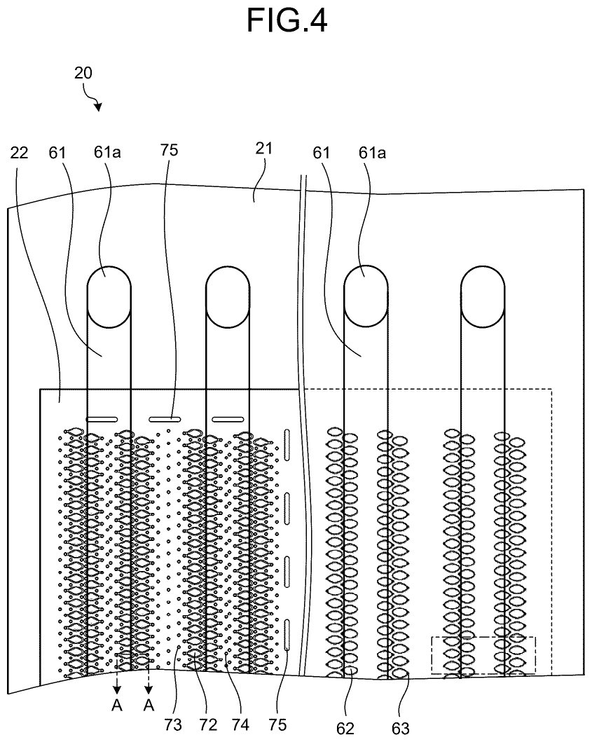

Then, droplet discharge is repeated in such a sealed space. As a result, it is possible to remove liquid, foreign matter, or the like clogged in the discharge hole 63 (see FIG. 4) and having viscosity higher than that in the standard state.

### Configuration of Droplet Discharge Head

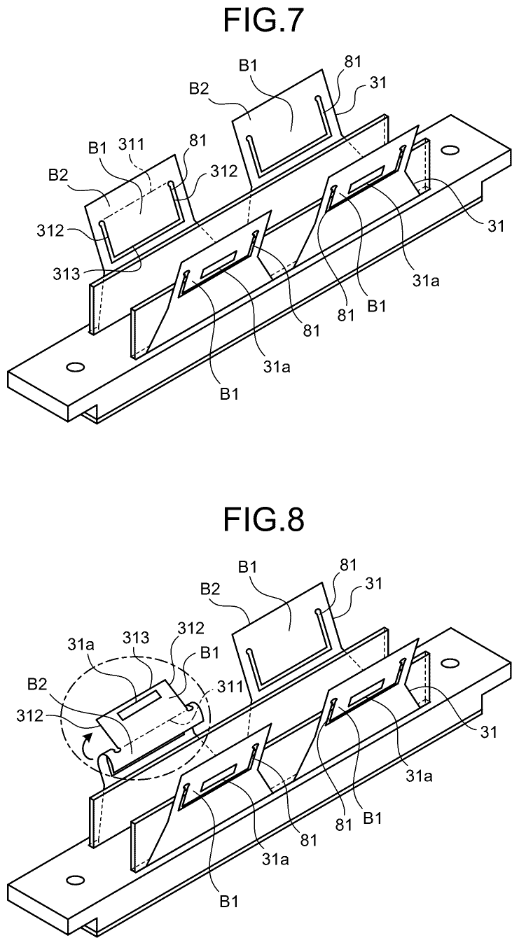

Then, a configuration of the droplet discharge head 8 according to the embodiment will be described with reference to FIG. 3. FIG. 3 is an exploded perspective view illustrating a schematic configuration of the droplet discharge head 8 according to the embodiment. In FIG. 3, a wiring portion 30 including a flexible substrate 31 is particularly schematically illustrated. A detailed configuration of the flexible substrate 31 according to the present embodiment is illustrated in FIGS. 7 to 15.

The droplet discharge head 8 includes a head body 20, a wiring portion 30, a housing 40, and a pair of heat dissipation plates 50. The head body 20 includes a channel member 21, a piezoelectric actuator substrate 22 (see FIG. 4), and a reservoir 23.

In the following description, the direction in which the head body 20 is provided in the droplet discharge head 8 is also referred to as “downward” for convenience. In the following description, the direction in which the housing 40 is provided with respect to the head body 20 is also referred to as “upward” for convenience.

The channel member 21 of the head body 20 has a substantially flat plate shape, and has a first surface 21a (see FIG. 6) that is one main surface and a second surface 21b (see FIG. 6) located on the opposite side of the first surface 21a. The first surface 21a has an opening 61a (see FIG. 4), and liquid is supplied from the reservoir 23 to the inside of the channel member 21 through the opening 61a.

The second surface 21b has a plurality of

discharge holes 63 (see FIG. 4) for discharging droplets onto the printing sheet P. A channel through which liquid flows from the first surface 21a to the second surface 21b is formed inside the channel member 21. The configuration of the channel member 21 will be described later with reference to FIGS. 4 to 6.

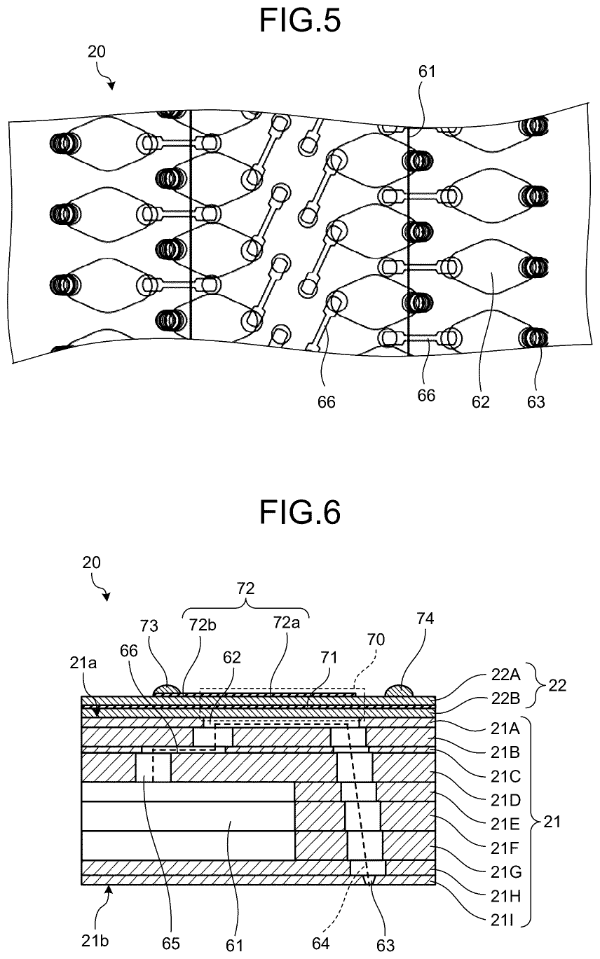

The piezoelectric actuator substrate 22 is located on the first surface 21a of the channel member 21. The piezoelectric actuator substrate 22 includes a plurality of displacement elements 70 (see FIG. 5). The flexible substrate 31 of the wiring portion 30 is electrically connected to the piezoelectric actuator substrate 22. The configuration of the piezoelectric actuator substrate 22 will be described later with reference to FIGS. 4 to 6.

The reservoir 23 is disposed on the piezoelectric actuator substrate 22. The reservoir 23 is provided with openings 23a at both ends in the main scanning direction. The reservoir 23 has a channel therein, and liquid is supplied from the outside through the opening 23a. The reservoir 23 has a function of supplying liquid to the channel member 21 and a function of storing the supplied liquid.

The wiring portion 30 includes a flexible substrate 31, a head substrate 32, a driver integrated circuit (IC) 33, a pressing member 34, and an elastic member 35. The flexible substrate 31 has a function of transmitting a predetermined signal sent from the outside to the head body 20. As illustrated in FIG. 3, the droplet discharge head 8 according to the embodiment includes two flexible substrates 31.

The first end of the flexible substrate 31 is electrically connected to the piezoelectric actuator substrate 22 of the head body 20. A second end of the flexible substrate 31 opposite to the first end is extended upward so as to pass through the opening 23b of the reservoir 23, and is electrically connected to the head substrate 32.

As a result, the piezoelectric actuator substrate 22 of the head body 20 can be electrically connected to the outside. The flexible substrate 31 is, for example, a film-like substrate (COF) made of polyimide, and the driver IC 33 and the like are mounted on the substrate. A detailed configuration of the flexible substrate 31 will be described later with reference to FIGS. 7 to 15.

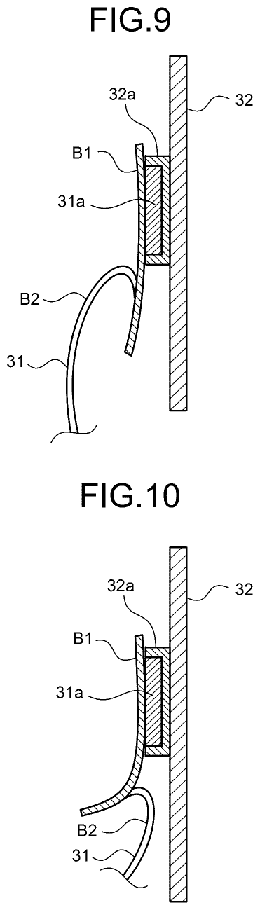

The head substrate 32 is located above the head body 20. The head substrate 32 has a function of distributing a signal to the driver IC 33. A connector (hereinafter, referred to as a first connector) 32a (see FIG. 9) to which the flexible substrate is connected is mounted on the head substrate 32.

The driver IC 33 is provided on one surface of the flexible substrate 31. As illustrated in FIG. 3, in the droplet discharge head 8 according to the embodiment, two driver ICs 33 are provided on one flexible substrate 31. In the embodiment, the number of driver ICs 33 provided on one flexible substrate 31 is not limited to two.

The driver IC 33 drives the piezoelectric actuator substrate 22 of the head body 20 based on a signal transmitted from the controller 14 (see FIG. 1). Thus, the driver IC 33 drives the droplet discharge head 8.

The pressing member 34 has a substantially U-shape in a cross-sectional view, and presses the driver IC 33 on the flexible substrate 31 from the inside toward the heat dissipation plate 50.

The elastic member 35 is located so as to be in contact with an outer wall of a pressing portion (not illustrated) of the pressing member 34. By providing such an elastic member 35, it is possible to reduce the possibility that the pressing member 34 damages the flexible substrate 31 when the pressing member 34 presses the driver IC 33.

The elastic member 35 is made of, for example, a foamed double-sided tape. For example, by using a non-silicon thermal conductive sheet as the elastic member 35, the heat dissipation of the driver IC 33 can be improved. Note that the elastic member 35 is not necessarily provided.

The housing 40 is disposed on the head body 20 so as to cover the wiring portion 30. Thus, the housing 40 can seal the wiring portion 30. The housing 40 is made of, for example, resin or metal.

The housing 40 has a box shape extending long in the main scanning direction, and has a first opening 40a and a second opening 40b on side surfaces facing each other in the sub-scanning direction. The first opening 40a and the second opening 40b are examples of the opening. The housing 40 has a third opening 40c on the lower surface and a fourth opening 40d on the upper surface.

One of the pair of heat dissipation plates 50 is disposed in the first opening 40a so as to close the first opening 40a. The other of the pair of heat dissipation plates 50 is disposed in the second opening 40b so as to close the second opening 40b.

The heat dissipation plate 50 is provided to extend in the main scanning direction, and is made of metal, alloy, or the like having high heat dissipation. The heat dissipation plate 50 is provided so as to be in contact with the driver IC 33, and has a function of dissipating heat generated in the driver IC 33.

The pair of heat dissipation plates 50 is fixed to the housing 40 by screws (not illustrated). Therefore, the housing 40 to which the heat dissipation plate 50 is fixed has a box shape in which the first opening 40a and the second opening 40b are closed and the third opening 40c and the fourth opening 40d are opened.

The third opening 40c is provided to face the reservoir 23. The flexible substrate 31 and the pressing member 34 are inserted through the third opening 40c.

The fourth opening 40d is provided for inserting a connector (not illustrated) provided in the head substrate 32. A space between the connector and the fourth opening 40d may be sealed with resin or the like. As a result, the effect of suppressing entering of liquid, dust, or the like into the housing 40 is improved.

The housing 40 includes a heat insulating portion 40e. The heat insulating portion 40e is disposed so as to be adjacent to the first opening 40a and the second opening 40b, and is provided so as to protrude outward from a side surface of the housing 40 facing in the sub-scanning direction.

The heat insulating portion 40e extends in the main scanning direction. That is, the heat insulating portion 40e is located between the heat dissipation plate 50 and the head body 20. By providing the heat insulating portion 40e in the housing 40 as described above, the effect of suppressing transfer of heat generated by the driver IC 33 to the head body 20 via the heat dissipation plate 50 is improved.

The droplet discharge head 8 may further include a member other than the member illustrated in FIG. 3.

### Configuration of Head Body

Then, a configuration of the head body 20 according to the embodiment will be described with reference to FIGS. 4 to 6. FIG. 4 is an enlarged plan view of the head body 20 according to the embodiment. FIG. 5 is an enlarged view of a region surrounded by an alternate long and short dash line illustrated in FIG. 4. FIG. 6 is a cross-sectional view taken along line A-A illustrated in FIG. 4.

As illustrated in FIG. 4, the head body 20 includes the channel member 21 and the piezoelectric actuator substrate 22. The channel member 21 includes a supply manifold 61, a plurality of pressurizing chambers 62, and a plurality of discharge holes 63.

The plurality of pressurizing chambers 62 are connected to the supply manifold 61. The plurality of discharge holes 63 are respectively connected to the plurality of pressurizing chambers 62.

The pressurizing chamber 62 is open to the first surface 21a (see FIG. 6) of the channel member 21. The first surface 21a of the channel member 21 has an opening 61a connected to the supply manifold 61. Then, liquid is supplied from the reservoir 23 (see FIG. 2) to the inside of the channel member 21 through the opening 61a.

In the example of FIG. 4, in the head body 20, four supply manifolds 61 are located inside the channel member 21. The supply manifold 61 has an elongated shape extending along the longitudinal direction (that is, in the main scanning direction) of the channel member 21, and openings 61a of the supply manifold 61 are formed in the first surface 21a of the channel member 21 at both ends thereof.

In the channel member 21, the plurality of pressurizing chambers 62 are formed to spread two-dimensionally. As illustrated in FIG. 5, the pressurizing chamber 62 is a hollow region having a substantially rhombic planar shape with rounded corners. The pressurizing chamber 62 is open to the first surface 21a of the channel member 21, and is closed by bonding the piezoelectric actuator substrate 22 to the first surface 21a.

The pressurizing chambers 62 constitute pressurizing chamber rows arranged in the longitudinal direction. The pressurizing chambers 62 in the pressurizing chamber rows are arranged in a staggered manner between two adjacent pressurizing chamber rows. Then, four pressurizing chamber rows connected to one supply manifold 61 constitute one pressurizing chamber group. In the example of FIG. 4, the channel member 21 includes four pressurizing chamber groups.

The relative arrangement of the pressurizing chambers 62 in the pressurizing chamber groups is the same, and the pressurizing chamber groups are slightly shifted in the longitudinal direction.

The discharge hole 63 is disposed at a position avoiding a region facing the supply manifold 61 in the channel member 21. That is, when the channel member 21 is viewed from the first surface 21a side, the discharge hole 63 does not overlap the supply manifold 61.

Furthermore, in plan view, the discharge hole 63 is disposed so as to be accommodated in a mounting region of the piezoelectric actuator substrate 22. Such discharge holes 63 occupy an area having substantially the same size and shape as those of the piezoelectric actuator substrate 22 as one group.

Then, by displacing the displacement element 70 (see FIG. 6) of the corresponding piezoelectric actuator substrate 22, droplets are discharged from the discharge hole 63.

As illustrated in FIG. 6, the channel member 21 has a stacked structure in which a plurality of plates are stacked. These plates are, in order from the upper surface of the channel member 21, a cavity plate 21A, a base plate 21B, an aperture (throttle) plate 21C, a supply plate 21D, manifold plates 21E, 21F, and 21G, a cover plate 21H, and a nozzle plate 21I.

A large number of holes are formed in the plate. The thickness of the plate is about 10 μm to 300 μm. Thus, the hole formation accuracy can be enhanced. The plates are aligned and stacked such that these holes communicate with each other to form a predetermined channel.

In the channel member 21, the supply manifold 61 and the discharge hole 63 are connected by an individual channel 64. The supply manifold 61 is located on the second surface 21b side inside the channel member 21. The discharge hole 63 is located on the second surface 21b of the channel member 21.

The individual channel 64 includes a pressurizing chamber 62 and an individual supply channel 65. The pressurizing chamber 62 is located on the first surface 21a of the channel member 21. The individual supply channel 65 is a channel connecting the supply manifold 61 and the pressurizing chamber 62.

The individual supply channel 65 includes a throttle 66 having a narrower width than other portions. Since the throttle 66 is narrower than the other portions of the individual supply channel 65, the channel resistance is high. As described above, when the channel resistance of the throttle 66 is high, the pressure generated in the pressurizing chamber 62 hardly escapes to the supply manifold 61.

The piezoelectric actuator substrate 22 includes piezoelectric ceramic layers 22A and 22B, a common electrode 71, an individual electrode 72, a connection electrode 73, a dummy connection electrode 74, and a surface electrode 75 (see FIG. 4).

In the piezoelectric actuator substrate 22, the piezoelectric ceramic layer 22A, the common electrode 71, the piezoelectric ceramic layer 22B, and the individual electrode 72 are stacked in this order.

Both the piezoelectric ceramic layers 22A and 22B extend on the first surface 21a of the channel member 21 so as to straddle the plurality of pressurizing chambers 62. Each of the piezoelectric ceramic layers 22A and 22B has a thickness of about 20 um. The piezoelectric ceramic layers 22A and 22B are made of, for example, a lead zirconate titanate (PZT)-based ceramic material having ferroelectricity.

The common electrode 71 is formed over substantially the entire surface in the plane direction in a region between the piezoelectric ceramic layer 22A and the piezoelectric ceramic layer 22B. That is, the common electrode 71 overlaps all the pressurizing chambers 62 in the region facing the piezoelectric actuator substrate 22.

The common electrode 71 has a thickness of about 2 μm. The common electrode 71 is made of a metal material such as Ag—Pd.

The individual electrode 72 includes a main body electrode 72a and an extraction electrode 72b. The main body electrode 72a is located in a region facing the pressurizing chamber 62 on the piezoelectric ceramic layer 22B. The main body electrode 72a is slightly smaller than the pressurizing chamber 62 and has a shape substantially similar to that of the pressurizing chamber 62.

The extraction electrode 72b is extracted from the main body electrode 72a to the outside of the region facing the pressurizing chamber 62. The individual electrode 72 is made of, for example, a metal material such as an Au-based metal material.

The connection electrode 73 is located on the extraction electrode 72b, and is formed in a convex shape with a thickness of about 15 μm. The connection electrode 73 is electrically connected to an electrode provided on the flexible substrate 31 (see FIG. 3). The connection electrode 73 is made of, for example, silver-palladium including glass frit.

The dummy connection electrode 74 is located on the piezoelectric ceramic layer 22B so as not to overlap with various electrodes such as the individual electrode 72. The dummy connection electrode 74 connects the piezoelectric actuator substrate 22 and the flexible substrate 31 to increase connection strength.

The dummy connection electrode 74 uniformizes distribution of contact positions between the piezoelectric actuator substrate 22 and the piezoelectric actuator substrate 22, and stabilizes electrical connection. The dummy connection electrode 74 may be made of the same material as the connection electrode 73, and may be formed in the same process as the connection electrode 73.

The surface electrode 75 illustrated in FIG. 4 is formed on the piezoelectric ceramic layer 22B at a position avoiding the individual electrode 72. The surface electrode 75 is connected to the common electrode 71 via a via hole formed in the piezoelectric ceramic layer 22B.

Thus, the surface electrode 75 is grounded and held at the ground potential. The surface electrode 75 is preferably made of a material equivalent to that of the individual electrode 72. The surface electrode 75 may be formed in the same process as the individual electrode 72.

Each of the plurality of individual electrodes 72 is electrically connected to the controller 14 (see FIG. 1) via the flexible substrate 31 and the wiring in order to individually control the potential. Then, when the individual electrode 72 and the common electrode 71 are set to different potentials and an electric field is applied in the polarization direction of the piezoelectric ceramic layer 22A, a portion in the piezoelectric ceramic layer 22A to which the electric field is applied operates as an active portion that is distorted by the piezoelectric effect.

That is, in the piezoelectric actuator substrate 22, portions of the individual electrodes 72, the piezoelectric ceramic layers 22A, and the common electrode 71 facing the pressurizing chambers 62 function as the displacement elements 70.

By unimorph deformation of the displacement element 70, the pressurizing chamber 62 is pressed and droplets are discharged from the discharge hole 63.

A driving procedure of the droplet discharge head 8 according to the embodiment will be described. The individual electrode 72 is previously set to a higher potential (hereinafter, referred to as high potential) than the common electrode 71. Then, every time there is a discharge request, the individual electrode 72 is once set to the same potential as the common electrode 71 (hereinafter, referred to as a low potential), and then set to a high potential again at a predetermined timing.

As a result, the piezoelectric ceramic layers 22A and 22B return to their original shapes at the timing when the individual electrode 72 has a low potential, and the volume of the pressurizing chamber 62 increases more than that in the initial state, that is, the high potential state. At this time, since a negative pressure is applied to the inside of the pressurizing chamber 62, the liquid in the supply manifold 61 is sucked into the pressurizing chamber 62.

Thereafter, the piezoelectric ceramic layers 22A and 22B are deformed so as to protrude toward the pressurizing chamber 62 at the timing when the individual electrode 72 is set to a high potential again. That is, as the volume of the pressurizing chamber 62 decreases, the pressure in the pressurizing chamber 62 becomes positive pressure. As a result, the pressure of the liquid in the pressurizing chamber 62 increases, and the droplets are discharged from the discharge hole 63.

That is, the controller 14 supplies a drive signal including a pulse based on a high potential to the individual electrode 72 using the driver IC 33 in order to discharge the droplets from the discharge hole 63. The pulse width may be set to an acoustic length (AL) which is a time length in which a pressure wave propagates from the throttle 66 to the discharge hole 63.

As a result, when the inside of the pressurizing chamber 62 is reversed from the negative pressure state to the positive pressure state, the pressures of the pressure chamber and the pressure chamber are combined, and the droplets can be discharged with a stronger pressure.

In the gradation printing, the gradation is expressed by the number of droplets continuously discharged from the discharge hole 63, that is, the droplet amount (volume) adjusted by the number of times of droplet discharge. Therefore, droplet discharge is continuously performed from the discharge hole 63 corresponding to the designated dot region a number of times corresponding to the designated gradation expression.

In general, when the droplet discharge is continuously performed, the interval between the pulses supplied for discharging the droplet may be set to AL. As a result, the cycle of the residual pressure wave of the pressure generated when the previously discharged droplet is discharged coincides with the cycle of the pressure wave of the pressure generated when the subsequently discharged droplet is discharged.

Therefore, it is possible to amplify the pressure for discharging the droplets by superimposing the residual pressure wave and the pressure wave. In this case, the speed of the droplets to be discharged later becomes faster, and the landing points of the plurality of droplets become closer to each other.

### Configuration of Flexible Substrate

Then, a configuration of the flexible substrate 31 according to the embodiment will be described with reference to FIGS. 7 to 15. FIGS. 7 and 8 are explanatory views of the flexible substrate 31 and a structure around the flexible substrate 31 according to the embodiment.

FIG. 7 illustrates a state in which a portion B1 of the flexible substrate 31 on which a second connector 31a to be described later is mounted is not turned inside-out. FIG. 8 illustrates a state in which one of the portions B1 (in the drawing, the portion B1 surrounded by an alternate long and short dash line) is turned inside-out. In FIGS. 7 and 8, illustration of a wiring pattern 85 (see FIG. 10) and the like formed in the flexible substrate 31 is omitted.

As illustrated in FIGS. 7 and 8, the flexible substrate 31 has a shape that gradually tapers into two as it goes upward. That is, the flexible substrate 31 has two upper portions protruding upward. A lower portion of the flexible substrate 31 is electrically connected to the piezoelectric actuator substrate 22 (see FIG. 4) of the head body 20 (see FIG. 3).

The second connector 31a is mounted on an upper portion of the flexible substrate 31. The second connector 31a is connected to the first connector 32a (see FIG. 9) mounted on the head substrate 32 (see FIG. 9), and can electrically connect the flexible substrate 31 and the head substrate 32.

The flexible substrate 31 allows the second connector 31a to be turned inside-out. The flexible substrate 31 is formed such that the portion B1 can be turned inside-out, and when the second connector 31a and the first connector 32a are connected, as illustrated in FIG. 8, the portion B1 is connected to the first connector 32a (see FIG. 9) in a state where the portion B1 is turned inside-out.

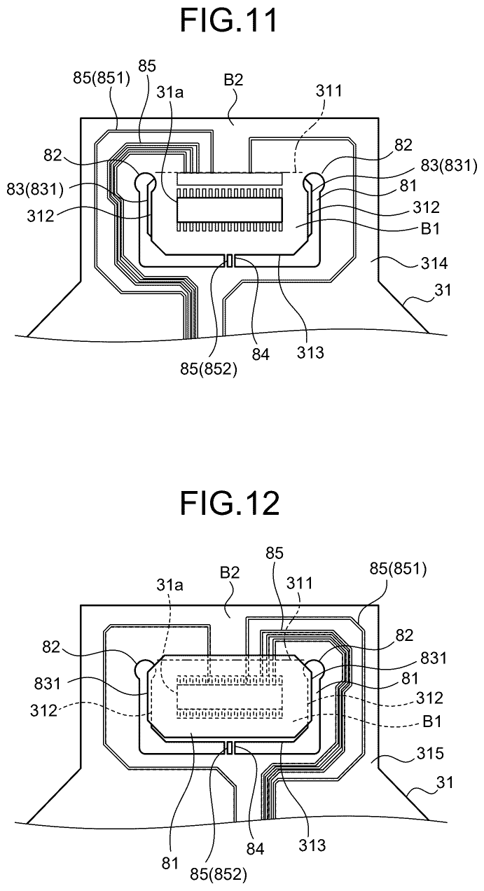

The portion B1 is separated from a portion (hereinafter, referred to as the other portion) B2 other than the portion B1 of the flexible substrate 31 where the second connector 31a is mounted by a slit portion 81 (see FIG. 11) described later, except for a part thereof.

In the present embodiment, an upper edge portion 311 of the portion B1 is connected to the other portion B2, and the pair of side edge portions 312 and a lower edge portion 313 are separated from the other portion B2. Therefore, in the connection state with the first connector 32a, the portion B1 is turned inside-out as well as upside-down with the upper edge portion 311 as a fulcrum.

The second connector 31a is connected to the first connector 32a by being fitted to the first connector 32a (receptacle). That is, the second connector 31a and the first connector 32a are connected to each other in a so-called B-to-B (Board-to-Board) manner. As described above, since the flexible substrate 31 and the head substrate 32 are connected in the B-to-B manner, the flexible substrate 31 and the head substrate 32 can be firmly connected.

Then, connection of the flexible substrate 31 will be described with reference to FIGS. 9 and 10. FIG. 9 is a schematic cross-sectional view illustrating connection of the flexible substrate 31. FIG. 10 is a schematic cross-sectional view illustrating another example of connection of the flexible substrate 31. Note that FIGS. 9 and 10 each illustrate a cross-section of the flexible substrate 31 taken along substantially the center in the width direction.

As illustrated in FIG. 9, in the flexible substrate 31, the second connector 31a, and the first connector 32a are connected in a state where the portion B1 is turned inside-out with an external rotation toward the head substrate 32. In other words, the other portion B2 adjacent to the portion B1 has a shape protruding outward when viewed from the side. As described above, the second connector 31a is turned inside-out, so that the second connector 31a reaches farther.

As illustrated in FIG. 10, the flexible substrate 31 may be connected in a state where the portion B1 is turned inside-out with an internal rotation toward the head substrate 32. In other words, the other portion B2 adjacent to the portion B1 has a shape protruding inward when viewed from the side. Even if the second connector 31a is turned inside-out with an internal rotation toward the first connector 32a, the second connector 31a reaches farther. Since the portion B1 can be connected in the state of being turned inside-out with either the external or internal rotation, the portion B1 can be selectively used according to the arrangement of the first connector 32a.

Then, the flexible substrate 31 will be further described with reference to FIGS. 11 and 12. FIG. 11 is an explanatory view of a front surface 314 of the flexible substrate 31. FIG. 12 is an explanatory view of a back surface 315 of the flexible substrate 31. Hereinafter, in the flexible substrate 31, the surface on which the second connector 31a is mounted is referred to as a “front surface 314”, and the opposite surface (back surface) is referred to as a “back surface 315”.

As illustrated in FIGS. 11 and 12, the flexible substrate 31 further includes the slit portion 81, a rounded portion 82, a reinforcing plate 83, and a tab 84. The slit portion 81 forms a gap having a predetermined width and is formed so as to surround the portion B1.

The slit portion 81 is formed to have a U shape when viewed to face the flexible substrate 31. Specifically, the portion B1 has a substantially rectangular shape in plan view, and as described above, the upper edge portion 311 of the portion B1 is connected to the other portion B2, and the pair of side edge portions 312 and the lower edge portion 313 are separated from the other portion B2. The slit portion 81 extends along the pair of side edge portions 312 and the lower edge portion 313 of the portion B1. Thus, the slit portion 81 has a U shape.

As described above, since the portion B1 is separated from the other portion B2 except for a part thereof by the slit portion 81, the portion B1 is not restricted. The “U-shape” is a shape formed by two parallel straight lines and one straight line connecting the opposing ends of the two straight lines.

Since the slit portion 81 has a U shape, the movable range of the portion B1 is substantially restricted in the thickness direction of the flexible substrate 31. As described above, since the movable range of the portion B1 is restricted in one direction, it is possible to improve the effect of suppressing the shift of the connection position between the second connector 31a and the first connector 32a (see FIG. 9).

The rounded portion 82 is formed at a proximal end portion of the slit portion 81, which is a boundary between the portion B1 and the other portion B2. Since the rounded portion 82 is formed at the proximal end portion of the slit portion 81 in this manner, concentration of stress at the proximal end portion of the slit portion 81 can be reduced. In the present embodiment, the rounded portion 82 is formed in a circular hole shape larger than the width of the slit portion 81, but may have other shapes, for example, a semicircular shape.

As illustrated in FIG. 12, the reinforcing plate 83 is provided on the back surface 315 of the flexible substrate 31. The reinforcing plate 83 is provided so as to cover the portion B1 on the back surface side of the portion B1 (the back surface 315 of the flexible substrate 31), thereby reinforcing the second connector 31a. In this manner, by the reinforcing plate 83 reinforcing the second connector 31a, it is possible to improve the effect of suppressing the damage of the second connector 31a at the time of attachment to and detachment from the first connector 32a (see FIG. 9).

The reinforcing plate 83 is made of hard plastic, for example, and is formed in a rectangular shape. The reinforcing plate 83 is transparent or translucent. The reinforcing plate 83 is chamfered at least at a corner located at a proximal end portion of the slit portion 81 among the four corners. As a result, the effect of suppressing interference with the rounded portion 82 can be improved.

As illustrated in FIGS. 11 and 12, the pair of side edge portions 831 of the reinforcing plate 83 protrudes from the portion B1 to the inside of the slit portion 81. In other words, the pair of side edge portions 831 of the reinforcing plate 83 is disposed inside the slit portion 81 in plan view. As described above, since the pair of side edge portions 831 of the reinforcing plate 83 is disposed inside the slit portion 81, the fingers are easily hooked on the pair of side edge portions 831 of the reinforcing plate 83, and the reinforcing plate 83 is easily held.

The tab 84 is bridged over the slit portion 81 so as to connect the portion B1 and the other portion B2 with the slit portion 81 interposed therebetween. Since the tab 84 is provided in this manner, the portion B1 can be fixed before the second connector 31a is turned inside-out.

In the flexible substrate 31, since the portion B1 is turned inside-out, the flexible substrate 31 is curved, and the flexible substrate 31 and the second connector 31a are not bonded to each other. When the bonding between the flexible substrate 31 and the second connector 31a is released, disconnection may occur from the wiring pattern 85 (851) at the outermost end of the second connector 31a. In the present embodiment, disconnection can be detected in the wiring pattern 851 at the outermost end. In this case, for example, if the wiring pattern 851 at the outermost end is a GND line, a high-level signal can be detected at the time of disconnection. In this way, disconnection of the wiring pattern 851 can be detected.

By making the wiring pattern 851 at the outermost end a GND line thicker than the other signal lines, it is also possible to electrically reinforce the other signal lines (wiring patterns 85) so as to protect them from noise and to mechanically reinforce the flexible substrate 31. Mechanical reinforcement of the flexible substrate 31 is effective in a configuration in which stress is likely to be applied to the flexible substrate 31 because the portion B1 is turned inside-out as in the present embodiment.

As illustrated in FIG. 12, a wiring pattern 85 (852) is also formed on the tab 84. Therefore, it is possible to visually confirm whether or not the wiring pattern 85 is formed at an appropriate position on the tab 84 at the time of forming the wiring pattern 852. Thus, the wiring pattern can be used as a marker for inspection as to whether or not the slit portion 81 is formed at an appropriate position.

### Another Embodiment of Flexible Substrate

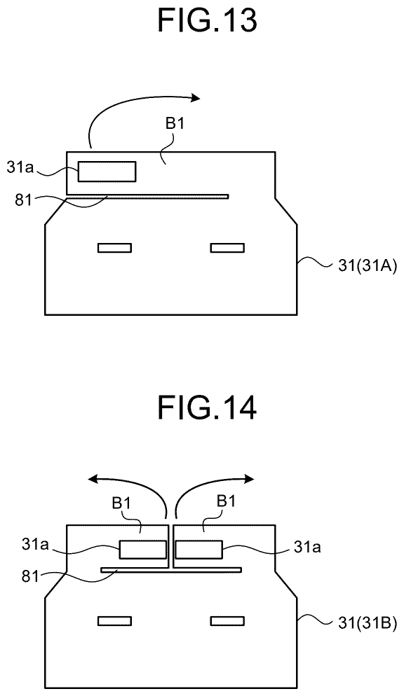

Then, another embodiment of the flexible substrate 31 will be described with reference to FIGS. 13 to 15. FIGS. 13 to 15 is an explanatory diagram of another embodiment of the flexible substrate 31. Note that FIGS. 13 to 15 schematically illustrates the flexible substrate 31 (31A to 31C). In such another embodiment, various variations of the slit portion 81 will be described.

As illustrated in FIG. 13, in the flexible substrate 31A according to another embodiment, the slit portion 81 is formed in a straight line along the width direction of the flexible substrate 31A. In the portion B1 formed in the slit portion 81, the second connector 31a is turned inside-out, so that the second connector 31a reaches farther.

As illustrated in FIG. 14, in the flexible substrate 31B according to another embodiment, the slit portion 81 is formed in a T shape at a central portion in the width direction of the flexible substrate 31A. The “T-shape” is a shape formed by one straight line and one straight line orthogonal to the straight line from an intermediate position of the one straight line.

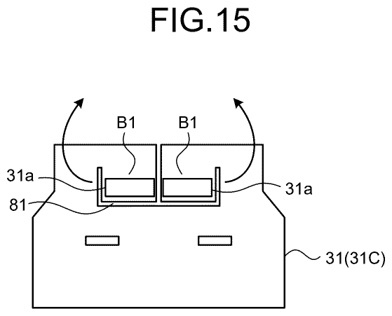

As illustrated in FIG. 15, in the flexible substrate 31C according to another embodiment, the slit portion 81 is formed in the following shape at the central portion in the width direction of the flexible substrate 31A. The slit portion 81 has a shape formed by two parallel first straight lines, one second straight line connecting ends of the first straight lines, and one third straight line orthogonal to the second straight line from an intermediate position of the second straight line. In the portion B1 formed by the slit portion 81, the degree of freedom of the position of the second connector 31a is high. As a result, in the flexible substrate 31A, the second connector 31a reaches a distant place while the length of the flexible substrate 31A in the height direction (vertical direction illustrated in FIG. 15) is kept small.

According to the droplet discharge head 8 according to the embodiment as described above, the head substrate 32 and the flexible substrate 31 can be connected in the B-to-B manner via the connectors (the first connector 32a and the second connector 31a). Therefore, the head substrate 32 and the flexible substrate 31 can be firmly connected, and reliability can be improved.

When the second connector 31a is turned inside-out, the second connector 31a reaches farther. That is, the flexible substrate 31 extends. As a result, a margin is created between the head substrate 32 and the first connector 32a, and the head substrate and the flexible substrate 31 can be effectively connected in a B-to-B manner.

For example, in a case where the flexible substrate 31 side with respect to the first connector 32a is a terminal, since a terminal such as tin is connected to a connector using gold plating, so-called intermetallic corrosion in which tin melts due to adhesion of moisture or the like occurs. In such a case, in general, gold plating cannot be performed on the terminal in the flexible substrate 31 such as the COF, and thus measures against intermetallic corrosion other than gold plating are required.

According to the droplet discharge head 8 of the embodiment, as described above, since the head substrate 32 and the flexible substrate 31 can be connected in the B-to-B manner, that is, since different metals are not used, the occurrence of metal corrosion between different types can be suppressed.

In a case where connectors are used for both the head substrate 32 and the flexible substrate, it is difficult to perform the B-to-B connection since the height of the flexible substrate 31 is limited. However, according to the droplet discharge head 8 according to the embodiment, as described above, the second connector 31a is turned inside-out, so that the second connector 31a reaches farther.

Since the flexible substrate 31 can be turned inside-out by the U-shaped slit portion 81, the second connector 31a can be mounted on the same surface as the terminal (actuator-side terminal) mounted on the flexible substrate 31 and/or the driver IC 33. As a result, the single-layer flexible substrate 31 can be used, and cost reduction can be achieved.

Since the portion B1 of the flexible substrate 31 is separated from the other portion B2 except for a part (the upper edge portion 311), the portion B1 is not restricted. As a result, the portion B1 can be flexibly deformed.

Since the rounded portion 82 is formed at the proximal end portion of the slit portion 81, concentration of stress at the proximal end portion of the slit portion 81 can be reduced. Thus, damage to the flexible substrate 31 can be suppressed.

By the reinforcing plate 83 reinforcing the second connector 31a, it is possible to improve the effect of suppressing the damage of the second connector 31a at the time of attachment and detachment to and from the first connector 32a.

Since the pair of side edge portions 831 of the reinforcing plate 83 protrudes toward the inside of the slit portion 81, the reinforcing plate 83 is easily held at the time of attachment and detachment to and from the first connector 32a. As a result, handleability can be improved.

Since the tab 84 is provided in the slit portion 81, the portion B1 can be fixed before the second connector 31a is turned inside-out. As a result, handleability can be improved.

Since the wiring pattern 852 is also formed on the tab 84, the wiring pattern 852 can be used as a marker for inspection as to whether the slit portion 81 is formed at an appropriate position.

According to the recording apparatus 1 according to the embodiment, in the droplet discharge head 8, the head substrate 32 and the flexible substrate 31 can be connected in the B-to-B manner via the connectors (the first connector 32a and the second connector 31a). Therefore, the head substrate 32 and the flexible substrate 31 can be firmly connected, and reliability can be improved.

When the second connector 31a is turned inside-out, the second connector 31a reaches farther. That is, the flexible substrate 31 extends. As a result, a margin is created between the head substrate 32 and the first connector 32a, and the head substrate and the flexible substrate 31 can be effectively connected in a B-to-B manner.

In the above embodiment, the slit portion 81 has a predetermined width, but for example, the slit portion 81 may be formed by a linear cut. Even when the slit portion 81 is a linear notch, the portion B1 can be turned inside-out.

Further effects and modifications can be easily derived by those skilled in the art. Thus, the broader aspects of the invention are not limited to the specific details and representative embodiments presented and described above. Accordingly, various changes may be made without departing from the spirit or scope of the general inventive concept as defined by the appended claims and their equivalents.

1. A droplet discharge head comprising:
a head body configured to discharge droplets;
a driver IC configured to control driving of the head body;
a flexible substrate on which the driver IC is mounted, the flexible substrate being electrically connected to the head body; and
a head substrate having a first connector, wherein
the flexible substrate includes a second connector corresponding to the first connector, and allows the second connector to be turned inside-out, and
the second connector is connected to the first connector in a state of being turned inside-out.

2. The droplet discharge head according to claim 1, wherein
a portion of the flexible substrate on which the second connector is mounted is formed to be turned inside-out.

3. The droplet discharge head according to claim 1, wherein
the flexible substrate has a U-shaped slit portion formed to surround a portion where the second connector is mounted.

4. The droplet discharge head according to claim 3, wherein
the flexible substrate has a rounded portion formed at a proximal end portion of the slit portion.

5. The droplet discharge head according to any one of claims 1, wherein
the flexible substrate includes a reinforcing plate on a back surface of a portion where the second connector is mounted.

6. The droplet discharge head according to claim 3, wherein
the flexible substrate includes a reinforcing plate on a back surface of a portion where the second connector is mounted, and
the reinforcing plate is provided so as to cover a portion where the second connector is mounted, and a side edge portion of the reinforcing plate protrudes from the portion where the second connector is mounted to an inner side of the slit portion.

7. The droplet discharge head according to claim 3, wherein
the flexible substrate includes a tab that connects a portion of the slit portion on which the second connector is mounted and a portion other than the portion where the second connector is mounted.

8. The droplet discharge head according to claim 7, wherein
a wiring pattern is formed on the tab of the flexible substrate.

9. A recording apparatus comprising:
the droplet discharge head according to claim 1.
